(19) United States
(12) Patent Application Publication
(10) Pub. No.: US 2006/0028169 A1
(43) Pub. Date: Feb. 9, 2006

(54) Retractable recharging system for remote controls

(76) Inventor: Tara Winn, Provo, UT (US)

Correspondence Address: STARKWEATHER & ASSOCIATES, 9035 S 1300 E, SUITE 200, SANDY, UT, 84094, US

(21) Appl. No.: 10/910,445

(22) Filed: Aug. 3, 2004

(51) Int. Cl. H02J 7/00

(52) U.S. Cl. 320/107

(57) ABSTRACT

An electronic device configured to be used in conjunction with a rechargeable wireless remote control and a plug housing integrated into the electronic device. The electronic device includes a door attached to the plug housing, and a charger cable with a plug configured to couple to the remote control, the charger cable slideably protruding into the plug housing. The charger cable is configured to conduct electricity from a power supply to the remote control to charge the remote control. The electronic device also includes a retractor coupled to the charger cable and configured to retract the charger cable into the electronic device and the plug into the plug housing. In one embodiment, a hoop attaches to the door such that when the plug retracts into the plug housing, the plug engages the hoop and draws the door shut. In one embodiment, the retractor draws a cable into the retractor, which draws the charger cable into the housing.

### BACKGROUND OF THE INVENTION

1. Field of the Invention

The present invention relates to a retractable recharging system for remote controls. Specifically, the present invention relates to a retractable cable within an electronic device that can be withdrawn to charge a wireless remote control and retracted into a housing when not in use.

2. Description of the Related Art

Virtually all television receivers, video cassette recorders (“VCR”), digital video disc (“DVD”) players, stereos, radios, and cable boxes are now manufactured with the capacity to operate by remote control. The remote control device may be a proprietary device manufactured by the maker of the television, VCR, DVD, etc, or it may be a universal remote control designed to operate with more than one brand name appliance. The remote control is usually designed to transmit a modulated infrared signal, which is received by the appliance. The transmitter is supplied with electrical power by one or more batteries. In order to avoid the expense of buying new batteries, the distributor or the consumer may use rechargeable batteries instead of disposable dry cell batteries.

Eventually the rechargeable battery runs down and requires recharging. Battery powered electrical devices may be designed in several ways. The battery powered device may have only a battery compartment, without any provision built into the device for recharging the batteries. In this event, the user must remove the rechargeable batteries from the device and insert the batteries into a general purpose battery charger purchased separately from the device.

The conventional rechargeable remote control suffers from several disadvantages. First, many rechargeable remote controls use remote charging bases. The bases are kept separate from the device controlled by the remote control and require an additional outlet. The remote charging bases require space, and are often unsightly in rooms decorated to hide the appearance of electronic equipment. Additionally, for remote controls with built in recharging circuitry, the remote controls are bulky. However, since remote controls are regularly dropped, sat on, laid on, stepped on, and tossed, additional recharging circuitry only increases the risk of failure.

It can be seen that there is a need for a retractable recharging system for remote controls that overcomes the aforementioned disadvantages. Specifically, there is a need for a retractable recharging system for remote controls that utilizes a standard rechargeable remote control that is capable of discretely storing and charging the remote control at the same time.

### SUMMARY OF THE INVENTION

The present invention has been developed in response to the present state of the art, and in particular, in response to the problems and needs in the art that have not yet been fully solved by currently available retractable recharging system for remote controls. Accordingly, the present invention has been developed to provide a retractable recharging system for remote controls that overcomes many or all of the above-discussed shortcomings in the art.

Specifically, the present invention provides an electronic device configured to be used in conjunction with a rechargeable wireless remote control and a plug housing integrated into the electronic device. The electronic device includes a door attached to the plug housing, and a charger cable with a plug configured to couple to the remote control, the charger cable slideably protruding into the plug housing. The charger cable is configured to conduct electricity from a power supply to charge the remote control. The electronic device also includes a retractor coupled to the charger cable and configured to retract the charger cable into the electronic device and the plug into the plug housing.

In one embodiment, a mechanism attaches to the door such that when the plug retracts into the plug housing, the plug engages the mechanism and draws the door shut.

In one embodiment, the retractor draws a cable into the retractor, which draws the charger cable into the housing.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention, as well as other features and advantages not listed, will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a retractable recharging system for remote controls wherein a retractor cable draws a charging cable according to one embodiment of the present invention; and

FIG. 2 illustrates a retractable recharging system for remote controls wherein the cord retracts onto a spool according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

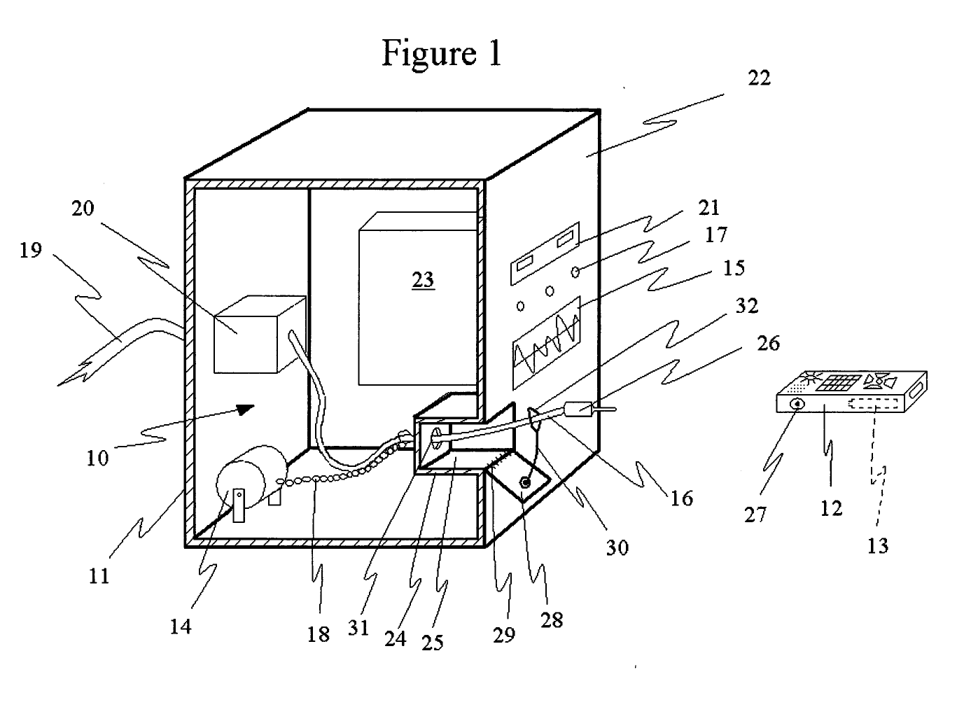

FIG. 1 illustrates a retractable recharging system 10 for remote control devices 12 according to one embodiment of the present invention. In one embodiment, the retractable recharging system 10 comprises a retractor 14 with a retractor cable 18 functionally coupled to the retractor 14 and coupled to a charging cable 16. The charging cable 16 conducts a current from a power cable 19 through a power supply 20 to the remote control device 12 where a male plug 26 removably couples to a female plug 27 of the remote control device 12. The charging cable 16 exits a radio 22 through a plug housing 24, which is configured to house the male plug 26. The plug housing 24 comprises a door 28, which opens at a hinge 29 to allow access to the male plug 26 when the male plug 26 is not in use.

The illustrated embodiment utilizes the radio 22 for showing how the current invention functions. However, the current invention may function with any type of remotely controlled electronic device, such as a television set (TV), a digital video disk player (DVD), a video cassette recorder (VCR), stereo, amplifier, computer, satellite receiver, cable box, or any other device with a wireless remote control. The radio 22 comprises a circuit box 23, a CD player 21, control knobs 17, and a graphic equalizer 15.

In one embodiment, the retractor cable 18 of the retractor 14 attaches to a section of the charging cable 16 to pull the charging cable 16 into the radio 22 and to pull the male plug 26 into a plug cavity 25 of the plug housing 24. The male plug 26 is configured to serve as a stop to prevent the male plug 26 from entering into the radio 22 through an aperture 31 in the plug housing 24. The aperture 31 has a diameter sufficiently large to allow the charger cable 16 to slide in and out of the plug housing 24, but small enough to engage the male plug 26 and prevent the male plug 26 from entering the radio 22. The retractor 14 may be spring loaded, motor driven, or comprise a coil spring, or other retracting means for allowing the retractor cable 18 a reliable and smooth transition from the retracted position to the charging position.

One embodiment of the present invention includes an automatic door closing device 30 attached to the door 28 of the plug housing 24. The door closing device 30 attaches to the housing door 28, preferably at an upper portion of the door 28 and wraps loosely around the charger cable 16 with a hoop 32. The hoop 32 is configured with an outer diameter and an inner diameter. The inner diameter is large enough to allow the charger cable 16 to slide through the hoop 32, yet small enough to prevent the male plug 26 from sliding through the inner diameter. The loosely wrapped hoop 32 allows the charger cable 16 to move freely in and out of the radio 22 without binding or snagging on the hoop 32.

The door 28 comprises a handle (not shown) on an outside portion of the door 28 to facilitate access to the male plug 26. When the handle is pulled and the door 28 opens, the door closing device 30 partially withdraws the male plug 26 from the plug housing 25.

In operation, when the door 28 is opened and the male plug 26 withdraws and is removed from the plug housing 24, the charger cable 16 is simultaneously withdrawn from the radio 22. As the user pulls the male plug 26, the charger cable 16 rides through the hoop 32. The male plug 26 plugs into the female plug 27 of the remote control device 12. After the remote control device 12 has charged, the male plug 26 detaches from the remote control device 12 and the retractor 14 draws the male plug 26 back into the plug housing 24. As the male plug 26 enters the plug housing 24, the hoop 32 engages the male plug 26 and pulls the door 28 closed. When the remote control device 12 is to be charged, the user simply opens the door 28, which partially removes the male plug 26 due to the engagement between the hoop 32 and the male plug 26, removes the charging cable 16 against the biased force of the retractor 14, and plugs the male plug 26 into the female plug 27 of the remote control device 12. Upon releasing from the remote control device 12, the retractor 14 draws the remote control device 12 into the plug housing 24, thus causing the male plug 26 and the hoop 30 to engage to automatically close the door 28. The door 28 may also be spring loaded to assist in closing the door 28.

In other embodiments, the plug housing 24 does not include a door 28; rather, the male plug 26 may be inserted similar to the method in which a cassette tape is inserted into a cassette player. Additionally, the male plug 26 may include notches (not shown) on the sides of the remote, which are configured to engage a receiving mechanism (not shown) within the plug housing 24. The male plug 26 may fit snugly within the plug housing 24 and eject with a push of an eject button (not shown). The male plug 26 may be magnetized on a side and magnetically adhere to a magnetic material (not shown) within the plug housing 24. One skilled in the art will recognize that there are numerous methods and devices for attaching the male plug 26 to the plug housing 24.

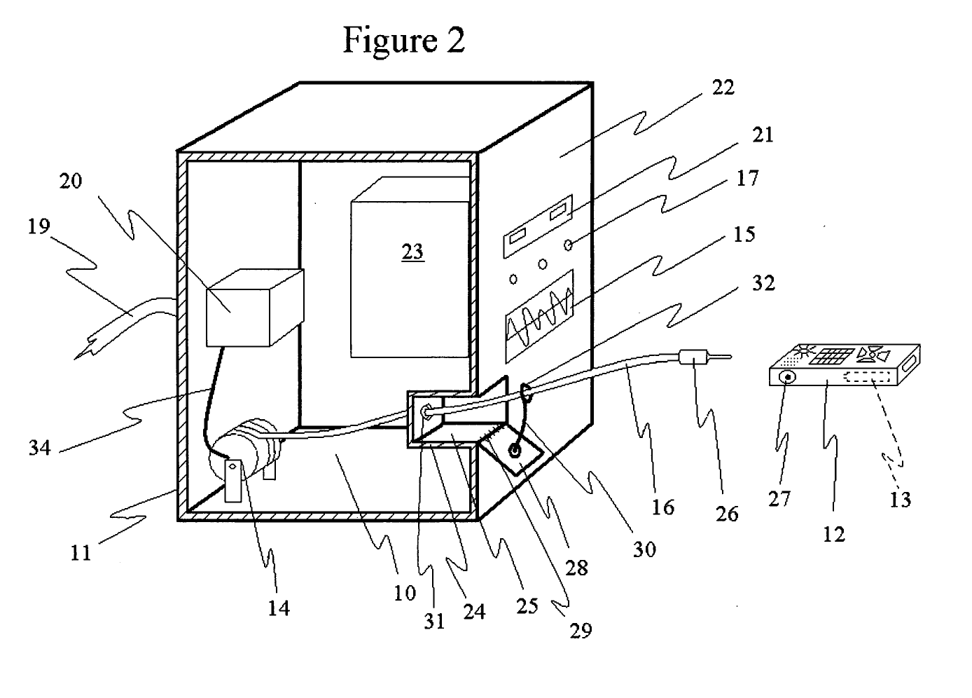

FIG. 2 illustrates a retractable recharging system 10 for remote control devices 12 according to one embodiment of the present invention. The retractor 14 of this embodiment retracts the charger cable 16 directly into a spool of the retractor 14. Wires 34 passing from the power supply 20 connect directly to the retractor 24 to conduct power to the remote control device 12. The charger cable 16 may retract to a spool (not shown) internally located within the retractor 14 or the charger cable 16 may simply wrap around a retracting mechanism (not shown) internally situated within the retractor 14. One skilled in the art will recognize that there are numerous devices that may be used for retracting the charger cable 16.

It is understood that the above-described arrangements are only illustrative of the application of the principles of the presently illustrated invention. The present invention may, however, be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment(s) of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An electrical device controlled by a rechargeable remote control, comprising:
an electronic device configured to be used in conjunction with a wireless remote control;
a plug housing integrated into the electronic device and having a door attached to the plug housing;
a charger cable with a plug configured to couple to the remote control, the charger cable slideably protruding into the plug housing and configured to conduct electricity from a power supply to the remote control to charge the remote control; and
a retractor coupled to the charger cable and configured to retract the charger cable into the electronic device and the plug into the plug housing.

2. The system according to claim 1, wherein the retractor comprises a retractor cable, which connects to the charger cable, and is configured to be drawn into the retractor to draw the charger cable into the electronic device.

3. The system according to claim 1, wherein the retractor draws the charger cable into the retractor.

4. The system according to claim 1, wherein the electronic device is a member selected from the group consisting of a DVD player, a radio, an amplifier, a stereo, a television, a VCR, a cassette player, a compact disc player, a recording device, a stereo, and a cable television box.

5. The system according to claim 1, wherein the plug housing is configured to hold the remote control after it has been plugged into the plug.

6. The system according to claim 1, wherein the plug housing comprises an aperture configured to allow the charger cable to move in and out and prevent the plug from entering inside the electronic device.

7. The system according to claim 7, wherein the door comprises a handle.

8. A retractable charging system for remote controls, comprising:
an electronic device configured to be used in conjunction with a wireless remote control;
a plug housing integrated into the electronic device and having a door attached to the plug housing;
a charger cable with a plug configured to couple to the remote control, the charger cable slideably protruding into the plug housing and configured to conduct electricity from a power supply to the remote control to charge the remote control;
a retractor coupled to the charger cable and configured to retract the charger cable into the electronic device and the plug into the plug housing; and
an automatic door closing device attached to the door, and configured to slideably hold the charger cable and engage the plug when the plug is retracted.

9. The system according to claim 8, wherein the retractor comprises a retractor cable, which connects to the charger cable, and is configured to be drawn into the retractor to draw the charger cable into the electronic device.

10. The system according to claim 8, wherein the retractor draws the charger cable into the retractor.

11. The system according to claim 8, wherein the electronic device is a member selected from the group consisting of a DVD player, a radio, an amplifier, a stereo, a television, a VCR, a cassette player, a compact disc player, a recording device, a stereo, and a cable television box.

12. The system according to claim 8, wherein the automatic door closing device is a hoop.

13. The system according to claim 8, wherein the plug housing is configured to hold the remote control after it has been connected to the plug.

14. The system according to claim 8, wherein the plug housing comprises an aperture configured to allow the charger cable to move in and out and prevent the plug from entering inside the electronic device.

15. The system according to claim 8, wherein the door comprises a handle.

16. The system according to claim 12, wherein the hoop has an inner diameter greater than the diameter of the charger cable but less than the diameter of the plug, the hoop configured such that when the retractor retracts the charger cable into the electronic device, the plug engages the hoop and draws the hoop into the plug housing, which pulls the door closed.
